(19) United States
(12) Patent Application Publication
(10) Pub. No.: US 2026/0331900 A1
(43) Pub. Date: Oct. 22, 2026

(54) TRANSIENT GROUND FAULT INTERRUPTER SYSTEM AND METHOD

(71) Applicant: Cheng USA, Inc., San Francisco, CA (US)

(72) Inventor: Michael T. Miles, Niles, MI (US)

(21) Appl. No.: 19/182,790

(22) Filed: Apr. 18, 2025

(51) Int. Cl. H02H 3/16; H02H 1/00

(52) U.S. Cl. CPC H02H 3/16; H02H 1/0007

(57) ABSTRACT

A transient ground fault interrupter circuit is provided, comprising: a sense coil configured to generate a voltage corresponding to a leakage current signal on current-carrying conductors between a power source and a safeguarded circuit; a comparator that receives the leakage current signal and a first current reference, and outputs a first fault signal if the leakage current signal exceeds the first current reference; a circuit configured to generate a steady-state leakage current signal using the leakage current signal; a difference amplifier configured to generate a transient leakage current signal from the steady-state leakage current signal and the leakage current signal; a comparator that receives the transient leakage current signal and a second current reference, and outputs a second fault signal if the difference signal exceeds the second current reference.

### TECHNICAL FIELD

The present disclosure relates to electrical power safety and more particularly to a transient ground fault interrupter circuit that causes power from a source to be disconnected from a safeguarded circuit including a load when transient leakage current exceeds a predetermined limit.

### BACKGROUND

Ground fault circuit interrupter (“GFCI”) devices are known and intended to improve the protection of humans from electric shock by shutting off electrical power when the device detects a ground fault. Such GFCI devices are typically required by law in certain locations such as where electrical fixtures such as receptacles are situated where water may be present (e.g., in kitchens, bathrooms, outdoor spaces, etc.). Standard GFCI devices are commonly integrated into the electrical fixtures or wired to protect a branch circuit containing a plurality of fixtures. However, upstream leakage current at the supply circuit or power source may also present a safety hazard.

Generally, if a supply current and a return current feeding a load are not the same, it is likely that some of the current is returning to the power source through a different path, other than the intended electrical conductors. The current differential is considered leakage current, since it flows from the power source line terminal but does not return through the neutral terminal. In the case of a split-phase or three-phase source, the current can return on the other phases also, but in every case the currents on all the phases and the neutral conductor ideally add up to zero. If the sum of those currents leaves a remaining current, then that is the leakage current. The leakage current must return through the grounding conductor or earth ground (the only other paths) instead, and that leakage current, if high enough, is considered a ground fault.

Leakage current may have various causes, and a small amount is normal, but the concern for personal electrical safety is that the current could be passing through a human body, which is a dangerous fault current. Thus, it is desirable to provide a supplemental protection circuit that functions to interrupt transient ground faults for one or more circuits that cannot be powered through a standard branch GFCI device.

### SUMMARY

In one embodiment, the present disclosure provides a system for reducing a risk of electrical shock to a human, comprising: a sense coil coupled to current-carrying conductors connected between a power source and a safeguarded circuit, the sense coil being configured to generate a voltage corresponding to a leakage current signal; a first comparator having a first input that receives the leakage current signal and a second input that receives a first current reference, the first comparator being configured to output a first fault signal in response to the leakage current signal exceeding the first current reference; a sampler configured to generate a steady-state leakage current signal by sampling the leakage current signal; a difference amplifier having a first input that receives the steady-state leakage current signal and a second input that receives the leakage current signal, the difference amplifier being configured to generate a transient leakage current signal corresponding to a difference between the steady-state leakage current signal and the leakage current signal; a second comparator having a first input that receives the transient leakage current signal and a second input that receives a second current reference, the second comparator being configured to output a second fault signal in response to the transient leakage current signal exceeding the second current reference; and a relay control coupled to the first comparator, the second comparator and a load relay coupled between the power source and the safeguarded circuit, the relay control being configured to respond to the first fault signal or the second fault signal by causing the load relay to disconnect the power source from the safeguarded circuit. One aspect of this embodiment further comprises an amplifier coupled between the sense coil and the first comparator, the sampler and the difference amplifier. In a variant of this aspect, the amplifier is configured to filter noise from the leakage current signal. In another aspect, the first current reference includes positive and negative threshold levels. In a variant of this aspect, the positive and negative threshold levels are approximately +42 mA and −42 mA, respectively. In yet another aspect of this embodiment, the second current reference includes positive and negative threshold levels. In a variant of this aspect, the positive and negative threshold levels are approximately +5 mA and −5 mA, respectively. In another aspect, the sampler is configured to sample the leakage current signal, store data representing the sampled leakage current signal in a memory device, and generate the steady-state leakage current signal from the stored data.

According to another embodiment, the present disclosure provides a method for reducing a risk of electrical shock to a human, comprising: measuring a leakage current signal on current-carrying conductors connected between a power source and a safeguarded circuit; responding to the leakage current signal exceeding a first current reference by causing a load relay to disconnect the power source from the safeguarded circuit; generating a steady-state leakage current signal by sampling the leakage current signal; determining a transient leakage current signal representing a difference between the steady-state leakage current signal and the leakage current signal; and responding to the transient leakage current signal exceeding a second current reference by causing the load relay to disconnect the power source from the safeguarded circuit. In one aspect of this embodiment, the method further comprises amplifying the leakage current signal. In another aspect, the method further comprises filtering the leakage current signal. In yet another aspect, responding to the leakage current signal exceeding the first current reference includes comparing the leakage current signal to positive and negative threshold levels of the first current reference. In a variant of this aspect, the positive and negative threshold levels are approximately +42 mA and −42 mA, respectively. In another aspect, responding to the transient leakage current signal exceeding the second current reference includes comparing the transient leakage current signal to positive and negative threshold levels of the second current reference. In a variant of this aspect, the positive and negative threshold levels are approximately +5 mA and −5 mA, respectively. In still another aspect of this embodiment, the steady-state leakage current includes sampling the leakage current signal, storing data representing the sampled leakage current signal in a memory device, and generating the steady-state leakage current signal from the stored data.

In yet another embodiment, the present disclosure provides a transient ground fault interrupter circuit, comprising: a sense coil configured to generate a voltage corresponding to a leakage current signal on current-carrying conductors connected between a power source and a safeguarded circuit; a first comparator having a first input that receives the leakage current signal and a second input that receives a first current reference, the first comparator being configured to output a first fault signal in response to the leakage current signal exceeding the first current reference; a circuit configured to generate a steady-state leakage current signal using the leakage current signal; a difference amplifier configured to generate a transient leakage current signal from the steady-state leakage current signal and the leakage current signal; and a second comparator having a first input that receives the transient leakage current signal and a second input that receives a second current reference, the second comparator being configured to output a second fault signal in response to the transient leakage current signal exceeding the second current reference. In one aspect of this embodiment, the circuit further comprises a relay control configured to cause a load relay to disconnect the power source from the safeguarded circuit in response to the first fault signal or the second fault signal. Another aspect further comprises an amplifier coupled between the sense coil and configured to amplify the leakage current signal. In a variant of this aspect, the amplifier is configured to filter noise from the leakage current signal. In another aspect, the circuit configured to generate a steady-state leakage current signal includes a sampler configured to sample the leakage current signal, store data representing the sampled leakage current signal in a memory device, and generate the steady-state leakage current signal from the stored data. In yet another aspect, the circuit configured to generate a steady-state leakage current signal averages changes in the leakage current signal over a period of time.

### BRIEF DESCRIPTION OF THE DRAWINGS

The above mentioned and other features of the present disclosure, and the manner of attaining them, will become more apparent and the invention itself will be better understood by reference to the following description of embodiments taken in conjunction with the accompanying drawings, wherein:

FIG. 1 is a schematic diagram of a transient ground fault interrupter (“TGFI”) circuit according to one embodiment of the present disclosure in a single-phase power circuit application;

FIG. 2 is a schematic diagram of a TGFI circuit according to one embodiment of the present disclosure in a three-phase power circuit application; and

FIG. 3 is a flow diagram of a method of responding to unacceptable leakage current variations in a power circuit according to one embodiment of the present disclosure.

Corresponding reference characters indicate corresponding parts throughout the several views. Unless stated otherwise the drawings are proportional and drawn to scale.

### DETAILED DESCRIPTION

The embodiments disclosed below are not intended to be exhaustive or to limit the invention to the precise forms disclosed in the following detailed description. Rather, the embodiments are chosen and described so that others skilled in the art may utilize their teachings.

The present disclosure provides a transient ground fault interrupter (“TGFI”) circuit that detects sudden changes in leakage current that exceed a predetermined threshold and shuts off power to a load in response. The TGFI circuit is not intended to provide overcurrent protection, which is provided by the mandated use of electrical safety devices such as circuit breakers. Electrical codes typically will require standard GFCI devices at receptacles in wet locations for complete protection.

Generally speaking, a TGFI circuit according to the present disclosure allows normal leakage current, which arises mostly from capacitive conduction of line voltage to the grounded conductor and to earth ground. The TGFI circuit detects sudden changes that are over a predetermined threshold such as, for example 5 mA in level, so that it can detect and protect a person suddenly touching a live conductor.

One aspect of the operation of a TGFI circuit according to the present disclosure is the establishment of the steady-state level, phase, and spectrum of the leakage current. This serves as the normal leakage current reference or reference leakage current. Any new additional transient change in leakage current (i.e., real-time leakage current) may be detected by comparing the real-time leakage current with the reference leakage current that existed during a previous predefined time period such as a few seconds. In certain embodiments, this operation can be performed using an auto-null circuit with an adaption time constant, or with digital signal processing that achieves the same thing. The system and method described herein uses a simplified digital version of this process.

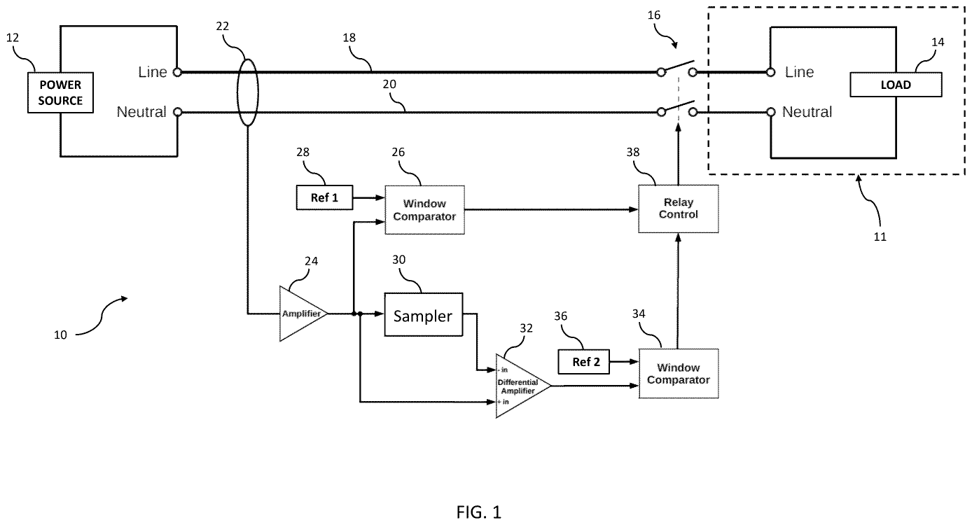

Referring now to FIG. 1, the operation of a TGFI circuit according to one embodiment of the present disclosure is shown in a single-phase application. In this application, the TGFI circuit 10 is connected to a circuit including a power source 12 connected to a load 14 by a load relay 16. The power source 12 may be a feeder circuit source or a branch circuit that supplies the load 14. The load 14 may represent any of a plurality of different circuits and/or devices such as, but not limited to, electrical equipment (e.g., motors, water heaters, etc.), receptacles, or if in a recreational vehicle (“RV”), a circuit breaker panel that feeds branch circuits. As shown, in this single-phase application, the power source 12 is connected to load 14 (when the load relay 16 is closed) by a line conductor 18 and a neutral conductor 20. The load relay 16 is used to disconnect the power source 12 from the safeguarded circuit 11 including the load 14 if a ground fault in the form of excessive leakage current occurs as is further described below. By disconnecting the power source 12 from the safeguarded circuit 11, the TFGI circuit 10 may reduce the risk of electrical shock to humans as well as protect the load 14 from damage due to high current sometimes induced by insulation degradation and/or moisture.

The TGFI circuit 10 includes a leakage current sense coil 22 which is placed around the conductors 18, 20 which carry the load current. The sense coil 22 senses the total magnetic field around the conductors 18. 20, which is essentially zero when the source current on the line conductor 18 is the same as the return current on the neutral conductor 20, which is the ideal condition. In most applications, however, the total magnetic field corresponds to a small current, often phase shifted from the line voltage due to capacitive coupling. This differential current in the conductors is referred to hereinafter as “the leakage current signal.”

In this application, the sense coil 22 produces a voltage that represents the leakage current between the line conductor 18 and the neutral conductor 20. As indicated above, the leakage current is generally small, so a voltage amplifier 24 may be used to increase the signal level. The amplifier 24 may also provide some deliberate filtering to remove radio frequency or other noise interference that could cause false tripping of the TGFI circuit 10. The output of the amplifier 24 is the leakage current signal, which is supplied to three different circuit sections. The leakage current signal may be conditioned in some applications, for example, in application where true rms detection is needed. In the implementation of FIG. 1, it is assumed that the leakage current signal is sinusoidal. In other words, the waveform of the leakage current signal should look similar to the line voltage waveform. As described below, the peak value of the leakage current signal is compared to a reference threshold.

The leakage current signal is provided as one input to a window comparator 26. The other input to the comparator 26 is a current reference (“Ref 1”) 28. The Ref 1 current reference 28, in one embodiment, is a threshold level of positive and negative 42 mA. These thresholds are the peak values of a sinusoidal 30 mA current. Of course, it should be understood that in other embodiments the Ref 1 current reference 28 could have other larger or smaller peak values. The Ref 1 current reference 28 provides a high limit threshold as a backstop that can be useful for equipment protection, and as a maximum limit for leakage current that may become dangerously high, but may somehow increase slowly rather than as a fast transient, which would be detected by the TGFI circuit 10. The use of the Ref 1 current reference 28 in this manner provides protection like a GFPE (ground fault protection for equipment), which functions like a GFCI except with a higher threshold. If the leakage current signal has peaks that exceed the thresholds of the Ref 1 reference current 28, then a fault signal is produced by the comparator 26.

The leakage current signal is also provided to a circuit for detecting transient changes. In one embodiment of the present disclosure, this circuit is represented by the sampler 30. In various embodiments, the sampler 30 may perform synchronous waveform averaging, synchronous sample averaging, signal averaging, time synchronous averaging, among other appropriate signal processing algorithms. In this embodiment, the waveform of the leakage current signal is sampled, such as with an analog-to-digital converter, and the samples are stored in a memory device with an algorithm. The waveform is then regenerated from the data in the memory device with a digital-to-analog converter. Upon sampling, while synchronized to the line frequency, the difference between the existing sample and the new sample, at the same place in the waveform, is that the samples are updated gradually instead of instantly, so that it takes a longer time for changes in the waveform to appear. In this sense the sampler 30 functions as a level sensing integrator which produces an averaged signal that changes relatively slowly compared to expected transients in the leakage current resulting from human contact with a live conductor. In certain embodiments, a low-pass or band-pass filter may be applied to the leakage current signal waveform in the sampler 30 before sampling to improve noise immunity. The result is that the regenerated signal is essentially the same as the leakage current signal, but with fast transients removed. This signal (referred to hereinafter as “the steady-state leakage current signal”) will vary continuously, but more slowly than the sampled waveforms, as it is adjusted to follow the smaller steps in the leakage current signal in either direction that are caused by intermittent equipment usage.

The steady-state leakage current signal is provided by the sampler 30 as one input to a differential amplifier 32. The other input to the differential amplifier 32 is the original leakage current signal from the amplifier 24. The differential amplifier 32 determines the difference between these two signals. The result, normally, is no signal because the steady-state leakage current signal is generally the same as the original leakage current signal.

When a sudden change in the leakage current signal occurs, however, the change by itself will appear at the output of the differential amplifier 32, with the steady-state portion of the leakage current signal removed because the samples processed by the sampler 30 are earlier in time and do not include the sudden change. This sudden change in the leakage current signal (referred to hereinafter as “the transient leakage current signal”) is provided by the differential amplifier 32 to one input of another window comparator 34.

The other input to the window comparator 34 is another current reference 36 (“Ref 2”). The Ref 2 current reference 36, in one embodiment, is a threshold level of positive and negative 7 mA. These thresholds are the peak values of a sinusoidal 5 mA current. Of course, it should be understood that in other embodiments the Ref 2 current reference 36 could have other larger or smaller peak values. If a peak value of the transient leakage current signal from the differential amplifier 32 exceed a threshold of the Ref 2 current reference 36, then the comparator 34 generates a fault signal.

If a fault signal is generated by either the comparator 26 or the comparator 34, then the fault signal is provided to a relay control 38. The relay control 38 is connected to the load relay 16 and responds to a fault signal from the comparators 26, 34 by causing the load relay 16 to open so that the safeguarded circuit 11 including the load 14 is disconnected from the power source 12. In certain embodiments, the load relay 16 and the TGFI circuit 10 may be reset manually, automatically, or by source power interruption, depending on the application.

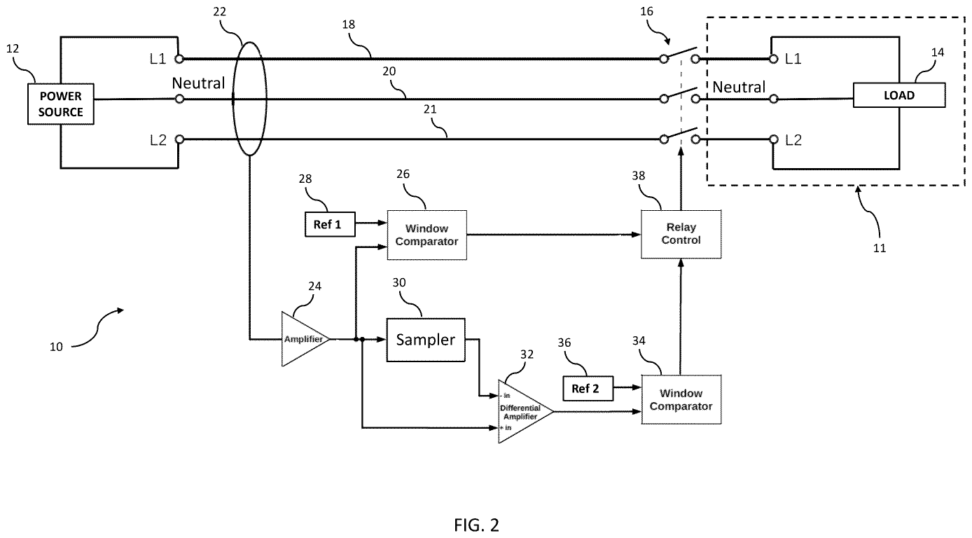

Referring now to FIG. 2, the TGFI circuit 10 is shown in a split-phase power application. The TGFI circuit 10 is the same as that depicted in FIG. 1 except the sense coil 22 detects the leakage current signal of three load current conductors. For split-phase power circuits, the sense coil 22 surrounds conductor 18 (“L1”), the neutral conductor 20 and conductor 21 (“L2”). For three-phase wye power circuits (not shown), the sense coil 22 surrounds an L1 conductor, an L2 conductor, an L3 conductor and a neutral conductor. For three-phase delta power circuits (not shown), the sense coil 22 surrounds an L1 conductor, an L2 conductor and an L3 conductor.

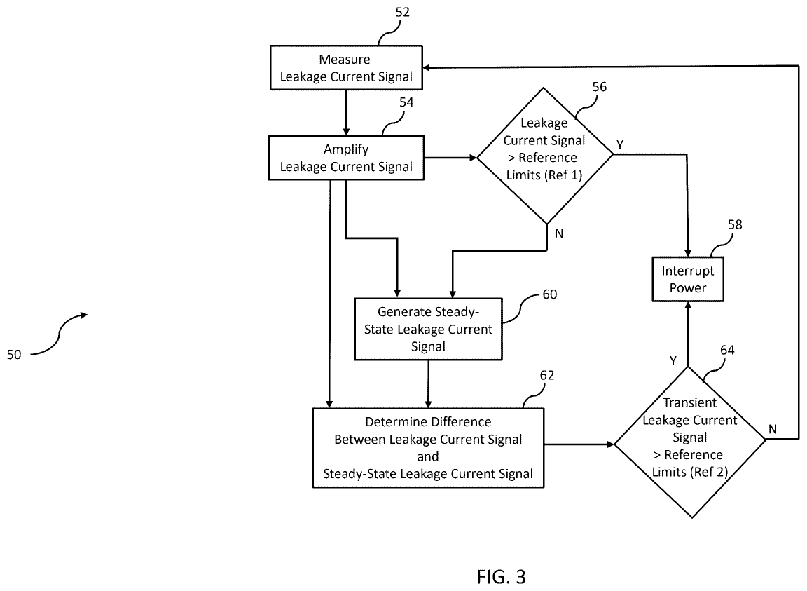

Referring now to FIG. 3, a method of responding to unacceptable leakage currents in a power circuit according to one embodiment of the present disclosure is shown. The method 50 begins at step 52 where the leakage current signal in the power circuit is measured by the sense coil 22 of the TGFI circuit 10 in the manner described above. In certain embodiments, the leakage current signal is amplified at step 54. This amplified leakage current signal is compared to a first set of reference current limits (i.e., Ref 1) at step 56 to detect whether the leakage current signal exceeds the current limits. If the peak values of the leakage current signal exceed the reference limits at step 56, then at step 58 the power supplied by the power source 12 to the safeguarded circuit 11 including the load 14 is interrupted by the relay control 38 which causes the load relay 16 to open as described above. If the leakage current signal does not exceed the current limits, then the method proceeds to step 60.

At step 60, the amplified leakage current signal from step 54 is sampled in the manner described above to generate the steady-state leakage current signal. As described above, each time the amplified leakage current signal is sampled, the steady-state leakage current signal is updated such that it represents the amplified leakage current signal over time with fast transients removed. Next, at step 62, the difference between the amplified leakage current signal from step 54 and the steady-state leakage current generated at step 60 is determined at step 62. As described above, the difference is the transient leakage current signal and represents a rapid or step change in the leakage current signal resulting from, for example, a human contacting a live conductor. At step 64, the transient leakage current signal is compared to a second set of reference limits (i.e., Ref 2). If the transient leakage current signal exceeds a reference limit, then at step 58 the power supplied by the power source 12 to the safeguarded circuit 11 including the load 14 is interrupted by the relay control 38 which causes the load relay 16 to open as described above. If the transient reference current signal does not exceed a reference limit, then the method returns to step 52 to continue measuring the leakage current signal.

Thus, the TGFI circuit 10 according to the present disclosure does not necessarily replace the standard GFCI protection that is used for circuits in wet areas and outdoors. The higher level of safety using the absolute maximum leakage current can protect against equipment leakage problems or other unusual or hazardous situations. The TGFI circuit 10 is intended, in certain embodiments, to provide additional protection for any of a variety of safeguarded circuits, including circuits that cannot be powered through a standard branch GFCI. This is accomplished by continuous monitoring of total ground fault current or the leakage current signal, and identifying rapid changes. If the leakage current signal changes quickly (e.g., in one step) by more than, for example, 5 mA, a fault is detected and the power to the safeguarded circuit is disconnected. Smaller transient changes (e.g., less than 5 mA), may be considered harmless and likely due to equipment operation, and power to the safeguarded circuit is maintained. A human touching a live conductor may quickly add more than 5 mA of current to the total leakage current. This step of leakage current is detected by the TGFI circuit 10 and power is immediately disconnected from the safeguarded circuit to help prevent injury. But normal equipment usage will create steps of current that are less than 5 mA, and those smaller steps will be allowed.

It should be understood that there may be a risk of false tripping at initial power-up of an entire system, with transient leakage current signals exceeding the 5 mA step threshold. This risk may be mitigated by using power sequencing with certain appliances, and/or by allowing a higher initial threshold just upon power-up, and then for a short time thereafter after the initial step has completed. Then, during subsequent normal operation, the TGFI circuit 10 may only allow transient leakage current signals of less than 5 mA as described above.

It should also be understood that a maximum total leakage current that could be reasonably expected in an entire power circuit may be used as a maximum threshold. This would define a static limit of leakage current over which power would be disconnected regardless of its dynamic behavior.

The TGFI circuit 10 according to the present disclosure may be used in conjunction with an RV ground monitor interrupter (“GMI”) or voltage monitor interrupter (“VMI”) device, so that in addition to testing the shore power wiring integrity, it would provide an additional level of shock protection for humans, thus improving the electrical safety of the system. The TGFI circuit 10 may be used on entire household or RV power panels where normal ground leakage of multiple devices adds up to higher than the protection threshold of, for example, 5 mA rms, which would cause false/nuisance tripping if a standard GFCI were applied to the entire circuit.

It should also be understood that, unless a term is expressly defined in this patent using the sentence “As used herein, the term ‘term’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, the patent claims at the end of this patent application are not intended to be construed under 35 U.S.C. § 112(f) unless traditional means plus-function language is expressly recited, such as “means for” or “step for” language being explicitly recited in the claim(s). The systems and methods described herein are directed to an improvement to computer functionality, and improve the functioning of conventional computer systems.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A system for reducing a risk of electrical shock to a human, comprising:
a sense coil coupled to current-carrying conductors connected between a power source and a safeguarded circuit, the sense coil being configured to generate a voltage corresponding to a leakage current signal;
a first comparator having a first input that receives the leakage current signal and a second input that receives a first current reference, the first comparator being configured to output a first fault signal in response to the leakage current signal exceeding the first current reference;
a sampler configured to generate a steady-state leakage current signal by sampling the leakage current signal;
a difference amplifier having a first input that receives the steady-state leakage current signal and a second input that receives the leakage current signal, the difference amplifier being configured to generate a transient leakage current signal corresponding to a difference between the steady-state leakage current signal and the leakage current signal;
a second comparator having a first input that receives the transient leakage current signal and a second input that receives a second current reference, the second comparator being configured to output a second fault signal in response to the transient leakage current signal exceeding the second current reference; and
a relay control coupled to the first comparator, the second comparator and a load relay coupled between the power source and the safeguarded circuit, the relay control being configured to respond to the first fault signal or the second fault signal by causing the load relay to disconnect the power source from the safeguarded circuit.

2. The system of claim 1, further comprising an amplifier coupled between the sense coil and the first comparator, the sampler and the difference amplifier.

3. The system of claim 2, wherein the amplifier is configured to filter noise from the leakage current signal.

4. The system of claim 1, wherein the first current reference includes positive and negative threshold levels.

5. The system of claim 4, wherein the positive and negative threshold levels are approximately +42 mA and −42 mA, respectively.

6. The system of claim 1, wherein the second current reference includes positive and negative threshold levels.

7. The system of claim 6, wherein the positive and negative threshold levels are approximately +5 mA and −5 mA, respectively.

8. The system of claim 1, wherein the sampler is configured to sample the leakage current signal, store data representing the sampled leakage current signal in a memory device, and generate the steady-state leakage current signal from the stored data.

9. A method for reducing a risk of electrical shock to a human, comprising:
measuring a leakage current signal on current-carrying conductors connected between a power source and a safeguarded circuit;
responding to the leakage current signal exceeding a first current reference by causing a load relay to disconnect the power source from the safeguarded circuit;
generating a steady-state leakage current signal by sampling the leakage current signal;
determining a transient leakage current signal representing a difference between the steady-state leakage current signal and the leakage current signal; and
responding to the transient leakage current signal exceeding a second current reference by causing the load relay to disconnect the power source from the safeguarded circuit.

10. The method of claim 9, further comprising amplifying the leakage current signal.

11. The method of claim 9, further comprising filtering the leakage current signal.

12. The method of claim 9, wherein responding to the leakage current signal exceeding the first current reference includes comparing the leakage current signal to positive and negative threshold levels of the first current reference.

13. The method of claim 12, wherein the positive and negative threshold levels are approximately +42 mA and −42 mA, respectively.

14. The method of claim 9, wherein responding to the transient leakage current signal exceeding the second current reference includes comparing the transient leakage current signal to positive and negative threshold levels of the second current reference.

15. The method of claim 14, wherein the positive and negative threshold levels are approximately +5 mA and −5 mA, respectively.

16. The method of claim 9, wherein generating the steady-state leakage current includes sampling the leakage current signal, storing data representing the sampled leakage current signal in a memory device, and generating the steady-state leakage current signal from the stored data.

17. A transient ground fault interrupter circuit, comprising:
a sense coil configured to generate a voltage corresponding to a leakage current signal on current-carrying conductors connected between a power source and a safeguarded circuit;
a first comparator having a first input that receives the leakage current signal and a second input that receives a first current reference, the first comparator being configured to output a first fault signal in response to the leakage current signal exceeding the first current reference;
a circuit configured to generate a steady-state leakage current signal using the leakage current signal;
a difference amplifier configured to generate a transient leakage current signal from the steady-state leakage current signal and the leakage current signal; and
a second comparator having a first input that receives the transient leakage current signal and a second input that receives a second current reference, the second comparator being configured to output a second fault signal in response to the transient leakage current signal exceeding the second current reference.

18. The transient ground fault interrupter circuit of claim 17, further comprising a relay control configured to cause a load relay to disconnect the power source from the safeguarded circuit in response to the first fault signal or the second fault signal.

19. The transient ground fault interrupter circuit of claim 17, further comprising an amplifier coupled between the sense coil and configured to amplify the leakage current signal.

20. The transient ground fault interrupter circuit of claim 19, wherein the amplifier is configured to filter noise from the leakage current signal.

21. The transient ground fault interrupter circuit of claim 17, wherein the circuit configured to generate a steady-state leakage current signal includes a sampler configured to sample the leakage current signal, store data representing the sampled leakage current signal in a memory device, and generate the steady-state leakage current signal from the stored data.

22. The transient ground fault interrupter circuit of claim 17, wherein the circuit configured to generate a steady-state leakage current signal averages changes in the leakage current signal over a period of time.
